(19) United States
(12) Patent Application Publication
(10) Pub. No.: US 2008/0151945 A1
(43) Pub. Date: Jun. 26, 2008

(54) Ultrashort stable mode locked fiber laser at one micron by using polarization maintaining (PM) fiber and photonic bandgap fiber (PBF)

(75) Inventor: Jian Liu, Sunnyvale, CA (US)

Correspondence Address: Bo-In Lin, 13445 Mandoli Drive, Los Altos Hills, CA, 94022, US

(73) Assignee: PolarOnyx, Inc.

(21) Appl. No.: 11/823,701

(22) Filed: Jun. 27, 2007

Related U.S. Application Data
(60) Provisional application No. 60/816,851, filed on Jun. 27, 2006.

(51) Int. Cl. H01S 3/30

(52) U.S. Cl. 372/6

(57) ABSTRACT

A fiber laser cavity that includes a laser gain medium for receiving an optical input projection from a laser pump. The mode-locked fiber laser further includes an all fiber based laser cavity including a dispersion management fiber segment for generating a negative (anomalous) to match a positive normal dispersion. The dispersion management fiber segment further coordinates with a polarization-controlling device for generating a polarization maintenance (PM) output laser pulse with a narrow pulse width.

This Formal Application claims a Priority date of June 27 benefited from a Provisional Application 60/816,851, filed by the same Applicant of this patent application. This Formal Application further claims a Priority Date of Jun. 21, 2006 Aug. 29, 2005 benefited from a Provisional Patent Applications 60/713,650, 60/713,653, and 60/713,654 and a Priority Date of Sep. 1, 2005 benefited from Provisional Applications 60/714,468 and 60/714,570 filed by one of the same Applicants of this Application.

### FIELD OF THE INVENTION

The present invention relates generally to apparatuses and methods for providing short-pulsed mode-locked fiber laser. More particularly, this invention relates to new configurations and methods for providing a photonic band-gap fiber based mode-locked fiber laser

### BACKGROUND OF THE INVENTION

Due to the nature of fiber materials, conventional silica fibers cannot generate negative dispersions. Therefore, a conventional fiber laser system configured by using the silica optical fibers must implement grating lens or prism-pairs to generate negative dispersions. It is necessary to generate a negative dispersion in a fiber laser system for providing a short pulse mode-locked laser system that can generate output laser with ultra-short pulse. The negative dispersions are necessary to overcome the technical difficulties caused by pulse shape distortions. Specifically, the practical usefulness of the ultra-short high power lasers are often hindered by the pulse shapes distortions as will be further explained and discussed below. Furthermore, when grating lens or prism pairs are implemented to correct the pulse shape distortions, such laser systems are often bulky, difficult for alignment maintenance, and also lack sufficient robustness. All these difficulties prevent practical applications of the ultra-short lasers. The following explanations are background information to better understand the why there is an urgent for providing the improved laser systems of this invention.

Historically, generation of mode-locked laser with the pulse width down to a femtosecond level is a difficult task due to limited resources of saturation absorbers and anomalous dispersions of fibers. Conventionally, short pulse mode locked fiber lasers operated at wavelengths below 1.3 μm present a particular challenge due to the fact that there is no simple all fiber based solution for dispersion compensation in this wavelength regime. (For wavelengths above 1.3 μm, several types of fibers exist exhibiting either normal or anomalous dispersion, so by splicing different lengths of fibers together one can obtain a cavity with an adjustable dispersion.) Therefore, previous researchers use bulk devices, such as grating pairs and prisms to provide an adjustable amount of dispersion for the cavity. Unfortunately these devices require the coupling of the fiber into a bulk device, which results in a laser that is highly sensitive to alignment and thus the environment

Several conventional techniques disclosed different semiconductor saturation absorbers to configure the ultra-short high power laser systems. However, such configurations often developed into bulky and less robust systems due to the implementations of free space optics. Such systems have been disclosed by S. N. Bagayev, S. V. Chepurov, V. M. Klementyev, S. A. Kuznetsov, V. S. Pivtsov, V. V. Pokasov, V. F. Zakharyash, A femtosecond self-mode-locked Ti:sapphire laser with high stability of pulserepetition frequency and its applications (Appl. Phys. B, 70, 375-378 (2000).), and Jones D. J., Diddams S. A., Ranka J. K., Stentz A., Windeler R. S., Hall J. L., Cundi® S. T., Carrierenvelope phase control of femtosecond mode-locked laser and direct optical frequency synthesis. (Science, vol. 288, pp. 635-639, 2000.). 70, 375-378 (2000).)

There is an urgent demand to resolve these technical difficulties as the broader applications and usefulness of the short pulse mode-locked are demonstrated for measurement of ultra-fast phenomena, micro machining, and biomedical applications. Different techniques are disclosed in attempt to resolve such difficulties. Such techniques include the applications of nonlinear polarization rotation (NLPR) or stretched mode locked fiber lasers as discussed above. As the NLPR deals with the time domain intensity dependent polarization rotation, the pulse shape distortions cannot be prevented due to the polarization evolution in both the time domain and the spectral domain. For these reasons, the conventional technologies do not provide an effective system configuration and method to provide effective ultra-short pulse laser for generating ultra-short laser pulses with acceptable pulse shapes.

In addition to the above described difficulties, these laser systems require grating pairs for dispersion control in the laser cavity. Maintenance of alignment in such systems becomes a time consuming task thus prohibiting a system implemented with free space optics and grating pairs from practical applications. Also, the grating pairs further add to the size and weight of the laser devices and hinder the effort to miniaturize the devices implemented with such laser sources.

In order to overcome such difficulties, the Applicant of the present invention discloses a fiber laser cavity in two prior patent application Ser. Nos. 11/093,519 and 11/136,040. The disclosures made in these two prior patent applications are hereby incorporated by reference. A fiber laser cavity is included in these two Applications that includes a laser gain medium for receiving an optical input projection from a laser pump. The fiber laser cavity further includes a positive dispersion fiber segment and a negative dispersion fiber segment for generating a net negative dispersion for balancing a self-phase modulation (SPM) and a dispersion induced pulse broadening-compression in the fiber laser cavity for generating an output laser with a transform-limited pulse shape.

However, since the conventional silica fibers cannot provide the required negative dispersions as that disclosed in these improved systems, a new and improved fiber that can generate negative dispersion is still required to overcome the above discussed difficulties and limitations. Therefore, a need still exists in the art of fiber laser design and manufacture to provide a new and improved laser system with new fibers to provide ultra-short mode-locked fiber laser cavity with better controllable pulse shapes such that the above discussed difficulty may be resolved.

### SUMMARY OF THE PRESENT INVENTION

It is therefore an aspect of the present invention to provide a method of using a negative (anomalous) dispersion generated by a photonic band-gap fiber (PBF) segment and a special fiber with negative dispersion slope or third order dispersion (TOD) by matching various fibers dispersion and dispersion slopes, dispersion management is employed in the fiber laser cavity to generate an output laser with a short pulse substantially between 10 to 400 femoto seconds.

Another aspect of this invention is to provide a design to achieve all fiber solution for 1 μm mode locked fiber laser by overcoming a difficulty that the nature of conventional fiber made by silica fiber material is not feasible to generate a negative (anomalous) dispersion. Due to that limitation, the self-phase modulation (SPM) and a dispersion induced pulse broadening-compression have to be compensated by grating pairs or prisms. The difficulty is resolved by using a Photonic bandgap fiber (PBF) as an improved fiber for manipulating and generating a negative dispersion for compensating and canceling the effects of self-phase modulation (SPM) and dispersion induced pulse broadening-compression.

Another aspect of this invention is to provide a mode locked fiber laser cavity with a polarization maintenance output laser from a all fiber-based laser cavity by utilizing a dispersion management fiber segment for generating a negative dispersion slope for matching a positive dispersion slope and for coordinating with a polarization controlling device for generating said PM output laser pulse.

Another aspect of this invention is to provide a mode locked fiber laser cavity with a polarization maintenance output laser from a all fiber-based laser cavity by utilizing a dispersion management fiber segment that includes a fiber segment of flat dispersion over a range of wavelengths or a fiber segment of negative dispersion slope (TOD) over a range of wavelengths wherein the first segment and second segment of fibers having a proper ratio of lengths for generating a flat dispersion in the laser cavity.

Another aspect of this invention is to provide a mode locked fiber laser cavity with a polarization maintenance output laser from a all fiber-based laser cavity by utilizing a PBF segment in said laser cavity for generating said negative (anomalous) dispersion and by lining up a slow axis of bi-refringent axes of the PBF with a PM mode port of a polarization beam splitter for outputting a PM output laser pulse.

Another aspect of this invention is to provide a mode locked fiber laser cavity with a polarization maintenance output laser from a all fiber-based laser cavity with narrow bandwidth with improved pulse shape by implementing a gain flatness filter. It is further an aspect of this invention to integrate the gain flatness filter in a mirror or the SESAM for conveniently implementing this gain flatness filter into the laser cavity for generating the polarization maintenance output laser pulse with ultra-short pulse width.

Briefly, this invention discloses a fiber laser cavity that includes a laser gain medium for receiving an optical input projection from a laser pump. The mode-locked fiber laser further includes an all fiber based laser cavity including a dispersion management fiber segment for generating a negative (anomalous) to match a positive normal dispersion. The dispersion management fiber segment further coordinates with a polarization-controlling device for generating a polarization maintenance (PM) output laser pulse with a narrow pulse width. In an exemplary embodiment, the polarization-controlling device includes a polarization beam splitter for transmitting a portion of a laser pulse in the laser cavity as an output laser. The dispersion management fiber management segment includes a photonic band gap fiber (PBF) segment for generating a negative abnormal dispersion for balancing a positive normal dispersion in the laser cavity wherein the PBF has birefringent polarization axes with a slow axis of the PBF lined up with a polarization mode (PM) mode port of the polarization beam splitter for generating the PM output laser pulse. In another exemplary embodiment, the laser cavity further includes a gain flatness filter to reduce a wavelength dependent effect of the laser cavity whereby a narrow pulse width of the PM output laser pulse may be achieved. In another exemplary embodiment, the dispersion management fiber segment further includes a fiber segment of flat dispersion over a range of wavelengths. In another exemplary embodiment, the dispersion management fiber segment further includes a fiber segment of negative dispersion slope (TOD) over a range of wavelengths. In another exemplary embodiment, the dispersion management fiber segment further includes a first fiber segment with an anomalous dispersion and a positive dispersion slope (TOD) and a second fiber segment with a positive (normal) dispersion and a negative dispersion slope (TOD) wherein the first segment and second segment of fibers having a proper ratio of lengths for generating a flat dispersion in the laser cavity.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 is functional block diagram for a short-pulse mode-locked fiber laser of this invention implementing a Photonics band-gap fiber (PBF).

FIG. 2 is functional block diagram for a short-pulse mode-locked fiber laser of this invention implementing a polarization maintenance (PM) fiber and a Photonics band-gap fiber (PBF).

FIGS. 3A and 3B illustrate the effects of implementing a gain flatness filter to broaden the gain spectrum of the laser pulse.

FIGS. 4A and 4B are two functional block diagram of a short-pulse mode-locked fiber laser implemented with a gain flatness filter.

FIG. 5 is a diagram for illustrating the management of the third order dispersion (TOD) by implementing different types of fibers in a laser cavity.

FIG. 6 is a diagram for illustrating the dispersion management in a fiber laser system.

FIGS. 7A and 7B are cross sectional views of a solid core and air core PBF fibers.

FIGS. 7C and 7D are curves for illustrating the variations of dispersions in the solid core and air-core PBF fibers of FIGS. 7A and 7B respectively.

### DETAILED DESCRIPTION OF THE INVENTION

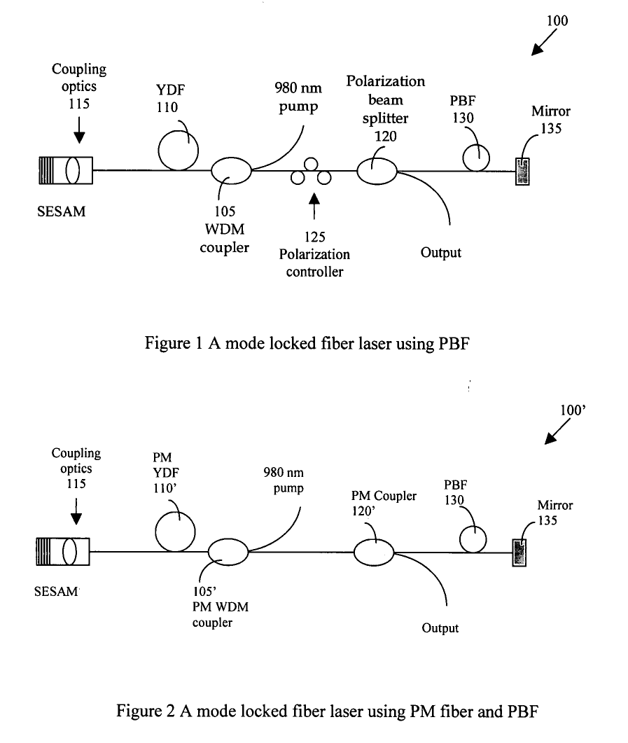

Referring to FIG. 1 for a schematic diagram of a mode locked fiber laser 100 of this invention. The fiber laser system includes wavelength division multiplexing (WDM) coupler 105 to receive a laser input from a 980 nm pump for combining with a one micron signal to project to a gain medium Ytterbium (Yb) doped fiber (YDF) 110. An amplified laser signal is transmitted to a semiconductor saturation absorber (SESAM) 115 and to a polarization beam splitter 120 via a polarization controller 125. The polarization controller 125 is placed in front of the polarization beam splitter 120 for adjusting of the output coupling-ratio. The fiber laser system further includes a photonic band-gap fiber (PBF) 130 that includes a mirror 135 placed on one end-face of the PBF 130 to reflect the signal back into the cavity. The photonic band-gap fiber (PBF) 130 is a newly available fiber which dispersion can be manipulated to negative (anomalous) dispersion. The function of the PBF and the manipulation of the negative (anomalous) dispersion will be further discussed below. Due to birefringence of the PBF 130, the polarization axis of the slow axis of one Polarization mode (PM) fiber port of the polarization beam splitter has to be lined up with that of the PBF. A slow axis is one of the polarization eigen-vectors. Along this axis, the polarization will not change along propagation. The benefit of this arrangement is to assure that there is no polarization mixing and maintain single polarization propagation. The SESAM used in the cavity is to help the mode locked fiber laser self-start. The SESAM has an intensity dependent transmittance while transmitting the strong portion of the pulse and block the weak portion of the pulse. This helps the pulse build up while resonance in the cavity.

In FIG. 2, the mode locked fiber laser 100′ has a similar configuration as that shown in FIG. 1 except that the fiber laser 100′ includes a piece of polarization maintaining (PM) Yb doped fiber (YDF) 110′ for amplification, a PM WDM coupler 105′ for combining 980 nm pump and 1 micron signal, a PM coupler 120′ with a certain coupling ratio (from 1% to 50%), a semiconductor saturation absorber (SESAM) 115, and a piece of PBF 130 for negative (anomalous) dispersion compensation. A mirror 135 is put on one endface of the PBF 130 to reflect the signal back into the cavity. Due to birefringence of the PBF, the polarization axis of the slow axis of one PM fiber port of the PM coupler has to be lined up with that of the PBF. The SESAM used in the cavity is to help the mode locked fiber laser self-start. PM fiber further enhances the performance of the mode locking operation because the fiber laser 100′ is more environmentally stable with the PM optical components as now included in the fiber laser 100′.

In addition to compensate the group velocity dispersion of various fibers (YDF, regular fiber, and PBF), in order to further reduce the pulse width of the mode locked fiber laser, this invention discloses techniques to further compensate the third order of dispersion (TOD) and uneven gain spectrum.

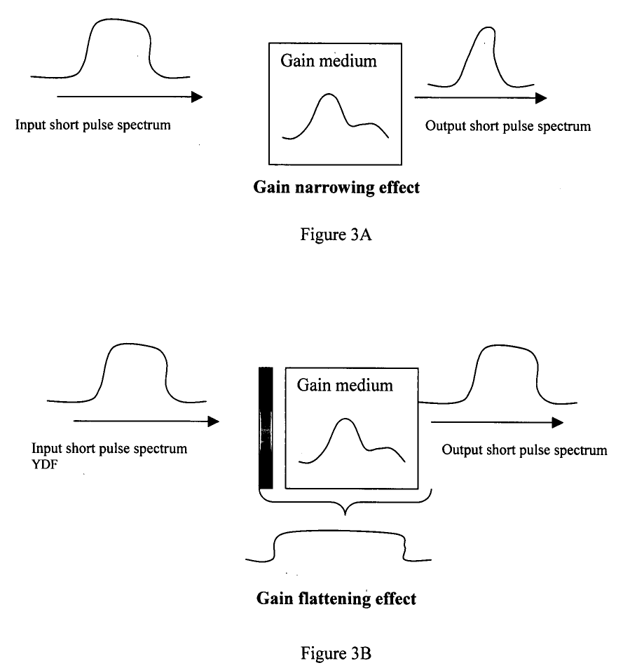

FIGS. 3A and 3B compare the output short pulse spectrums provided by a fiber laser without and with a gain-flatness filter in the laser cavity respectively. The purpose of using a gain flatness filter is to avoid any gain narrowing effect which always happens in any types of gain medium that have uneven wavelength dependent emission properties. FIG. 3A illustrates that the gain shape as shown in the output laser spectrum is highly wavelength dependent when the fiber laser cavity is configured without a gain flattening filter. For a short pulse with wide spectrum, it tends to narrow the spectrum after going through the gain medium for amplification. FIG. 3B illustrates a fiber laser implemented with a gain flatness filter that is designed to have a special shape to compensate the uneven gain shape intrinsic to the gain medium. FIG. 3B illustrates the combination of the filter and gain medium provides an equivalent flat gain shape. Therefore, when a pulse is amplified, the output laser pulse maintains an original spectrum without any narrowing effects.

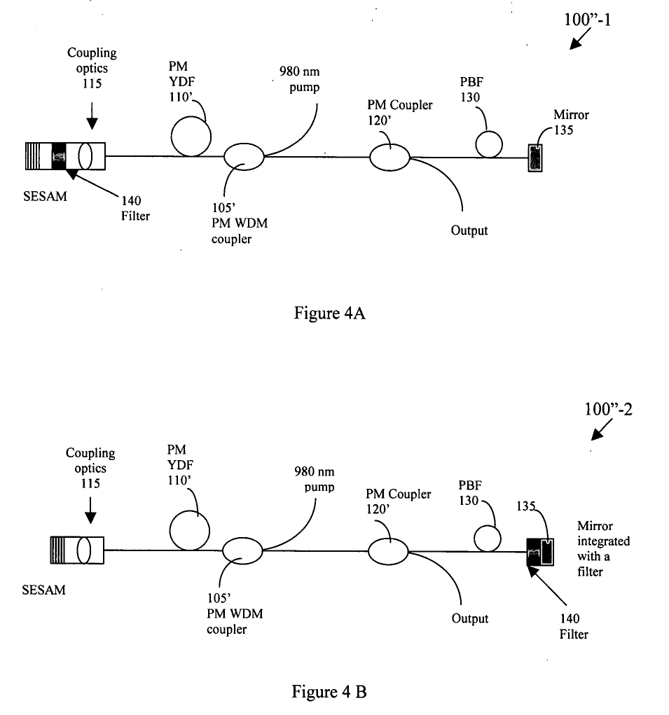

In principle, the flatness gain filter can be put in any location of the laser cavity. Practically, for convenience of implementation, the gain flatness filter are integrated either with the SESAM 115 and/or mirror 135 as illustrated in FIGS. 4A and 4B. In FIG. 4A, a gain flatness filter 140 is integrated into the SESAM 115 and in FIG. 4B, the gain flatness filter 140 is integrated with the mirror 135.

FIGS. 4A and 4B show a fiber laser 100″-1 and 100″-2 that implement a method to reduce the TOD effects by introducing a special fiber with zero and/or negative dispersion slope (TOD) with conventional fiber. An alternate design to configure the fiber laser cavities 100″-1 and 100-2 is to implement a fiber that has a flat dispersion, referred to as the “New fiber”, or with a negative dispersion slope, referred to as a “New fiber-2”, over the range of 1020-1090 nm, by using a depressed cladding structure.

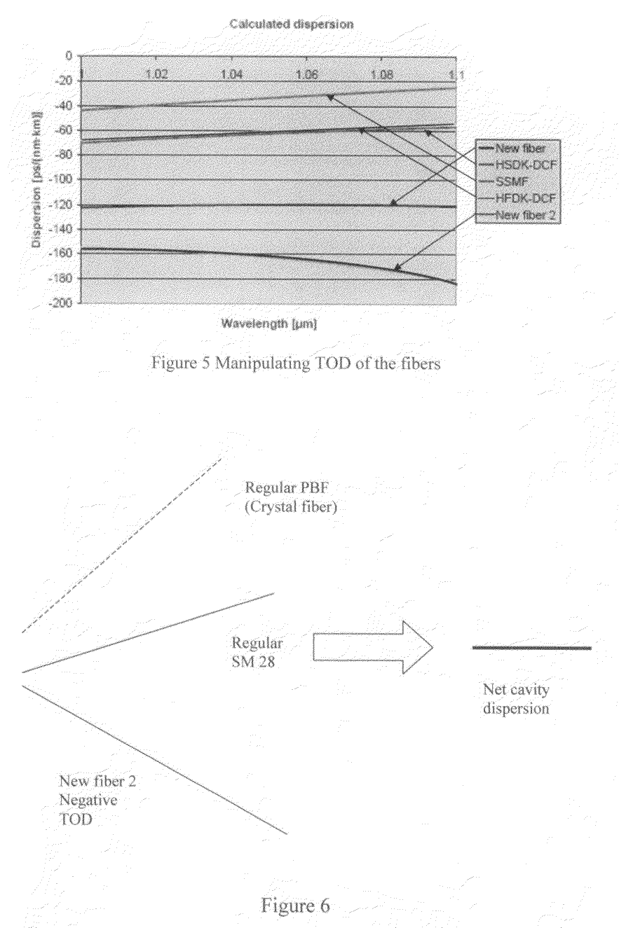

FIG. 5 is a diagram to illustrate an example of the index profile for this type of fiber and possible dispersion at 1060 spectral band. Depending on the laser design in managing/compensating TOD with the nonlinear effects (self phase modulation SPM), fibers with various dispersion and dispersion slope can be designed. FIG. 5 illustrates that the New fiber has a flat dispersion over the spectral range of 1060 nm and New fiber 2 has a negative dispersion slope (about twice that of SM 28). More over, due to the positive dispersion properties, the new fiber 2 can be used with other types of commercial fibers such as SM 28 (SSMF, Corning) and dispersion compensation fiber HSDK (OFS, Denmark) to achieve various dispersions and dispersion slopes in tailoring the dispersion of the fiber laser. The HSDDCF and SSMF-HFDK-DCF fibers are commonly known by those of ordinary skill in the art and these fibers are shown in FIG. 5 for comparison and references purposes only. According to FIG. 5, it shows an example of combining two different types of fiber to get a flat dispersion with a net negative (anomalous) dispersion and zero dispersion slope (TOD). The PBF fiber has an anomalous dispersion and positive slope and New fiber 2 has a positive (normal) dispersion and negative slope (TOD). By combining with proper ratio of lengths between them, it is possible to get a flat dispersion and positive and negative dispersion slopes (TODs). Therefore, in an exemplary embodiment, the laser cavity includes two categories of fibers: a first category that comprises a PBF fiber and a second category that includes special fiber (New 1 and New 2. The PBF has anomalous dispersion and positive dispersion slope; the special fiber has normal (positive) dispersion and negative (new 2) or flat (new 1) dispersion slope.

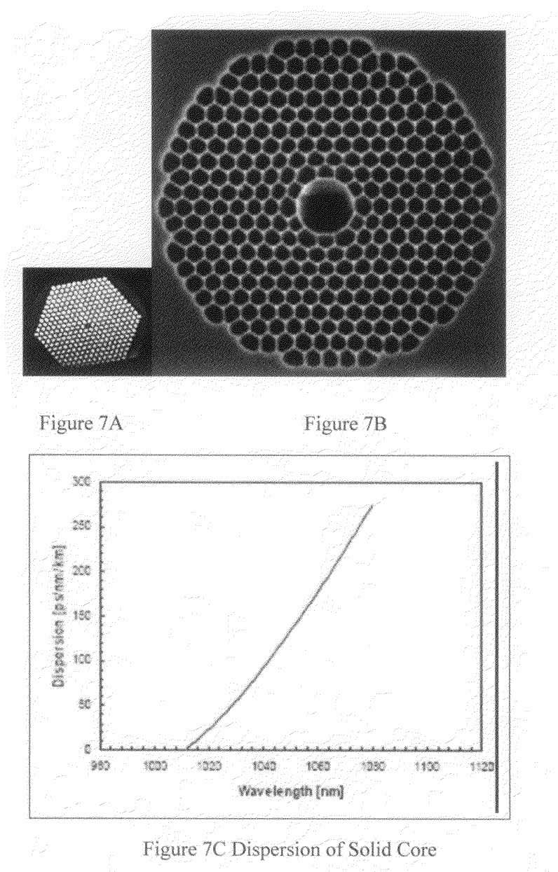

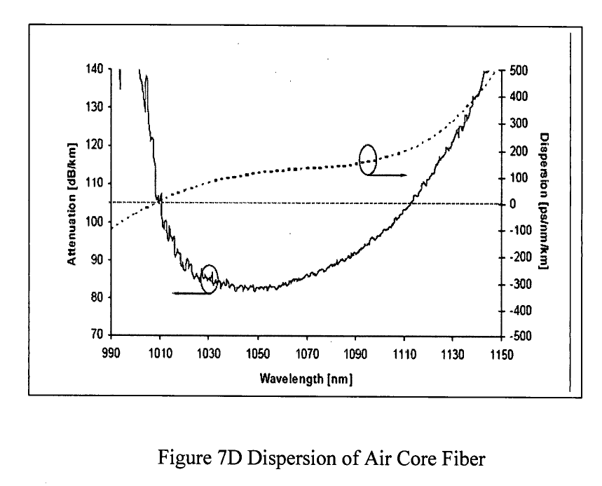

FIG. 6 shows various schemes for managing the dispersion by applying an ideal technique of dispersion compensation to generate a net dispersion of the laser cavity by combining various types of fibers. Further more, PBF can also be designed to achieve flat and negative TOD by manipulating the structure of air holes. A PCF (photonic crystal fiber) can also play a similar role. FIGS. 7A and 7B show the cross sections of a solid core and air core PBF fibers and FIGS. 7C and 7D are curves for illustrating the dispersions of the laser transmission in the fiber for the solid core and the air core fibers. The negative (anomalous) dispersions as that illustrated in FIG. 7D of the PBF with air core can be utilized to carry out dispersion management through matching the positive (normal) and the negative (anomalous) dispersions.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. A fiber laser cavity comprising a laser gain medium for receiving an optical input projection from a laser pump, wherein:
said mode-locked fiber laser further comprising an all fiber based laser cavity including dispersion management fiber segments for generating a negative dispersion slope to match a positive dispersion slope (TOD); and
said dispersion management fiber segments further coordinating with a polarization controlling device for generating a polarization maintenance (PM) output laser pulse with a narrow pulse width.

2. The fiber laser cavity of claim 1 wherein:
said polarization controlling device comprising a polarization beam splitter for transmitting a portion of a laser pulse in said laser cavity as an output laser; and
said dispersion management fiber management segments comprising a photonic band gap fiber (PBF) segment for generating a negative abnormal dispersion for balancing a positive normal dispersion in said laser cavity wherein said PBF has birefringent polarization axes with a slow axis of said PBF lined up with a polarization mode (PM) mode port of said polarization beam splitter for generating said PM output laser pulse.

3. The fiber laser cavity of claim 1 further comprising:
a gain flatness filter to reduce a wavelength dependent effect of said laser cavity whereby a narrow pulse width associated with a wider gain bandwidth of said PM output laser pulse may be achieved.

4. The fiber laser cavity of claim 1 further wherein:
said dispersion management fiber segment further includes a fiber segment of flat dispersion over a range of wavelengths.

5. The fiber laser cavity of claim 1 further wherein:
said dispersion management fiber segment further includes a fiber segment of negative dispersion slope (TOD) over a range of wavelengths.

6. The fiber laser cavity of claim 1 further wherein:
said dispersion management fiber segment further includes a first fiber segment with an anomalous dispersion and a positive dispersion slope (TOD) and a second fiber segment with a positive (normal) dispersion and a negative dispersion slope (TOD) wherein said first segment and second segment of fibers having a proper ratio of lengths for generating a flat dispersion in said laser cavity.

7. The fiber laser cavity of claim 1 further comprising:
a gain medium further comprising a Ytterbium doped fiber (YDF) for amplifying said laser pulse transmitted in said laser cavity.

8. The fiber laser cavity of claim 1 further comprising:
a wavelength division multiplexing device for coupling to said laser pump for receiving said optical input projection.

9. The fiber laser cavity of claim 1 further comprising:
a semiconductor saturation absorber (SESAM) to enhance a self-start operation of the fiber laser cavity by performing a function of intensity dependent transmittance and wherein said SESAM is integrated with a gain flatness filter.

10. The fiber laser cavity of claim 1 further comprising:
a mirror disposed an end-face of the PBF to reflect a laser projection back into said fiber laser cavity and said mirror is further integrated with a gain flatness filter.

11. The fiber laser cavity of claim 1 further comprising:
a polarization controller disposed between said gain medium and said polarization beam splitter for adjusting an output coupling ratio between said laser pulse transmitted in said laser cavity and said output laser pulse transmitted through said polarization beam splitter.

12. The fiber laser cavity of claim 1 further comprising:
a polarization coupler for coupling a portion of laser pulses for outputting from said laser cavity.

13. The fiber laser cavity of claim 1 wherein:
said gain medium further comprising a polarization maintaining (PM) Ytterbium doped fiber (YDF) for amplifying said laser pulse transmitted in said laser cavity.

14. The fiber laser cavity of claim 1 wherein:
said gain medium further comprising a polarization maintaining (PM) Ytterbium doped fiber (YDF) for amplifying said laser pulse transmitted in said laser cavity; and
said fiber laser cavity further comprises a wavelength division multiplexing (WDM) device and a PM WDM coupler for coupling to said laser pump for receiving said optical input projection.

15. The fiber laser cavity of claim 1 wherein:
said gain medium further comprising a polarization maintaining (PM) Ytterbium doped fiber (YDF) for amplifying said laser pulse transmitted in said laser cavity; and
said fiber laser cavity further comprises a wavelength division multiplexing (WDM) device and a PM WDM coupler for coupling to said laser pump for receiving said optical input projection with a certain coupling ratio between 1% to 50% to said laser pulse transmitted in said laser cavity.

16. The fiber laser cavity of claim 1 further comprising:
a gain flatness filter for reducing a spectrum narrowing effect of said laser cavity whereby a wavelength dependent output pulse distortion is reduced.

17. The fiber laser cavity of claim 1 further comprising:
a semiconductor saturation absorber (SESAM) to enhance a self-start operation of the fiber laser cavity by performing a function of intensity dependent transmittance wherein said SESAM further comprising an integrated gain flatness filter whereby a wavelength dependent output pulse distortion is reduced.

18. The fiber laser cavity of claim 1 further comprising:
a mirror disposed an end-face of the PBF to reflect a laser projection back into said fiber laser cavity wherein said mirror further comprising an integrated gain flatness filter whereby a wavelength dependent output pulse distortion is reduced.

19. The fiber laser cavity of claim 1 further comprising:
a fiber of a zero dispersion slope (TOD) to compensate a third order dispersion in said fiber laser cavity.

20. The fiber laser cavity of claim 1 further comprising:
a fiber of a negative abnormal dispersion slope (TOD) to compensated a third order dispersion in said fiber laser cavity.

21. The fiber laser cavity of claim 1 further comprising:
a fiber using a depressed cladding structure with a negative abnormal dispersion slope (TOD) to compensated a third order dispersion in said fiber laser cavity.

22. A method for generating a polarization maintenance (PM) output laser from a laser cavity comprising:
utilizing a dispersion management fiber segment for generating a negative (anomalous) for matching a positive normal dispersion and for coordinating with a polarization controlling device for generating said PM output laser pulse.

23. The method of claim 22 wherein:
said step of utilizing said dispersion management fiber segment further comprising a step of utilizing a PBF segment in said laser cavity for generating said negative (anomalous) dispersion; and
said step of coordinating with a polarization controlling device further comprising a step of lining up a slow axis of bi-refringent axes of said PBF with a PM mode port of a polarization beam splitter for outputting a PM output laser pulse.

24. The method of claim 22 further comprising:
implementing a gain flatness filter for improving a gain shape of said PM output laser pulse whereby a narrow pulse width of said PM output laser pulse is achieved.
